(19) United States
(12) Patent Application Publication
(10) Pub. No.: US 2020/0075220 A1
(43) Pub. Date: Mar. 5, 2020

(54) MULTILAYER COIL COMPONENT AND METHOD OF MANUFACTURING MULTILAYER COIL COMPONENT

(71) Applicant: Murata Manufacturing Co., Ltd., Kyoto-fu (JP)

(72) Inventors: Tomoyuki WADA, Nagaokakyo-shi (JP); Kiyoyasu SAKURADA, Nagaokakyo-shi (JP); Yoshiyuki OOTA, Nagaokakyo-shi (JP); Kouki OKAMURA, Nagaokakyo-shi (JP)

(73) Assignee: Murata Manufacturing Co., Ltd., Kyoto-fu (JP)

(21) Appl. No.: 16/538,581

(22) Filed: Aug. 12, 2019

(30) Foreign Application Priority Data
Aug. 29, 2018 (JP) 2018-160317

(51) Int. Cl. H01F 27/28; H01F 17/04; H01F 17/00; H01F 1/34; H01F 41/04; H01F 41/12

(52) U.S. Cl. CPC H01F 27/2804; H01F 17/04; H01F 17/0013; H01F 2027/2809; H01F 41/041; H01F 41/12; H01F 1/34

(57) ABSTRACT

A multilayer coil component includes an element body that includes a plurality of insulating layers laminated together, a coil that is embedded in the element body and that includes a plurality of coil conductor layers provided between the insulating layers, and a first outer electrode and a second outer electrode each of which is provided on an outer surface of the element body and each of which is electrically connected to the coil. When viewed in cross section in a lamination direction in which the plurality of insulating layers are laminated together, end surfaces of the coil conductor layers, the end surfaces facing outward of the element body, are substantially straight in the lamination direction, and end surfaces of the coil conductor layers, the end surfaces facing inward of the element body, are inclined or bent with respect to the lamination direction.

### CROSS-REFERENCE TO RELATED APPLICATION

This application claims benefit of priority to Japanese Patent Application No. 2018-160317, filed Aug. 29, 2018, the entire content of which is incorporated herein by reference.

### BACKGROUND

### Technical Field

The present disclosure relates to a multilayer coil component and a method of manufacturing a multilayer coil component.

### Background Art

In general, a multilayer coil component includes an element body that is formed by laminating a plurality of insulating layers, a coil that is embedded in the element body and that is formed of coil conductor layers provided between the insulating layers, and first and second outer electrodes that are provided on outer surfaces of the element body and electrically connected to the coil.

For example, such a multilayer coil component is manufactured by forming outer electrodes onto outer surfaces of a multilayer body that is obtained by laminating and integrating sheets for insulating layers and patterns for coil conductor layers together and then firing these sheets and patterns.

As a multilayer coil component, Japanese Unexamined Patent Application Publication No. 2001-44039 discloses a chip ferrite component that includes a magnetic ferrite body that is made of a magnetic ferrite material and an inner conductor that is embedded in the magnetic ferrite body so as to form a coil and that is disposed such that at least a portion of the inner conductor that corresponds to an intermediate portion of the coil is exposed to the outside of the magnetic ferrite body. Japanese Unexamined Patent Application Publication No. 2001-44039 describes that it is preferable that at least a portion of the inner conductor that is exposed to the outside of the magnetic ferrite body be coated with a non-magnetic material.

### SUMMARY

In the chip ferrite component described in Japanese Unexamined Patent Application Publication No. 2001-44039, since at least a portion of the inner conductor that corresponds to the intermediate portion of the coil is disposed so as to be exposed to the outside of the magnetic ferrite body, an open magnetic circuit structure is formed at least in the portion, and thus, direct-current superposition characteristics are improved. However, this is not sufficient for reducing a direct-current resistance Rdc, and it can be said that there is room for improvement.

Accordingly, the present disclosure provides a multilayer coil component capable of reducing a direct-current resistance. In addition, the present disclosure provides a method of manufacturing the above-mentioned multilayer coil component.

A multilayer coil component according to preferred embodiments of the present disclosure includes an element body that includes a plurality of insulating layers laminated together, a coil that is embedded in the element body and that includes a plurality of coil conductor layers provided between the insulating layers, and a first outer electrode and a second outer electrode that are provided on outer surfaces of the element body and that are electrically connected to the coil. When viewed in cross section in a lamination direction in which the plurality of insulating layers are laminated together, end surfaces of the coil conductor layers, the end surfaces facing outward of the element body, are substantially straight in the lamination direction, and end surfaces of the coil conductor layers, the end surfaces facing inward of the element body, are inclined or bent with respect to the lamination direction.

A method of manufacturing a multilayer coil component according to preferred embodiments of the present disclosure includes fabricating a mother multilayer body including a plurality of insulating layers that are laminated together and a coil-conductor-layer pattern that is provided between the insulating layers, dividing the mother multilayer body into a plurality of green multilayer bodies each of which includes a coil that is formed of a coil conductor layer provided between the laminated insulating layers by cutting the mother multilayer body, the green multilayer bodies each having a cut surface that is formed as a result of cutting the mother multilayer body and at which the coil conductor layer is exposed, forming a side-margin portion on the cut surface of each of the multilayer bodies, at which the coil conductor layer is exposed, by using an insulating material, and firing the multilayer bodies each of which includes the side-margin portion.

According to preferred embodiments of the present disclosure, a multilayer coil component capable of reducing a direct-current resistance can be provided.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view schematically illustrating an example of a multilayer coil component according to a first embodiment of the present disclosure;

FIG. 2 is a perspective view schematically illustrating an example of an element body that is included in the multilayer coil component illustrated in FIG. 1;

FIG. 3 is a perspective view schematically illustrating an example of a multilayer body that is prepared for fabricating the element body illustrated in FIG. 2;

FIG. 4 is an exploded perspective view of the multilayer body illustrated in FIG. 3;

FIG. 5 is a sectional view of the element body illustrated in FIG. 2 taken along line A-A;

FIG. 6 is an enlarged cross-sectional view schematically illustrating an example of a coil conductor layer having an end surface that faces inward of the element body and that is inclined with respect to a lamination direction;

FIG. 7 is an enlarged cross-sectional view schematically illustrating an example of a coil conductor layer having an end surface that faces inward of the element body and that is bent with respect to the lamination direction;

FIG. 8 is an enlarged cross-sectional view schematically illustrating another example of a coil conductor layer having an end surface that faces inward of the element body and that is bent with respect to the lamination direction;

FIG. 9 is a sectional view schematically illustrating a case where two coil conductor layers are provided on one insulating layer such that the two coil conductor layers are superposed with each other;

FIG. 10A, FIG. 10B, FIG. 10C, FIG. 10D, FIG. 10E, FIG. 10F, and FIG. 10G are plan views schematically illustrating examples of insulating sheets that are laminated together in order to obtain a mother multilayer body;

FIG. 11A, FIG. 11B, FIG. 11C, FIG. 11D, FIG. 11E, FIG. 11F, and FIG. 11G are plan views schematically illustrating other examples of insulating sheets that are laminated together in order to obtain a mother multilayer body;

FIG. 12 is an enlarged cross-sectional view schematically illustrating an example of a coil-conductor-layer pattern that is to be cut;

FIG. 13 is an enlarged cross-sectional view schematically illustrating another example of a coil-conductor-layer pattern that is to be cut;

FIG. 14 is a perspective view schematically illustrating another example of the element body that is included in the multilayer coil component illustrated in FIG. 1;

FIG. 15 is a perspective view schematically illustrating an example of a multilayer body that is prepared for fabricating the element body illustrated in FIG. 14;

FIG. 16 is an exploded perspective view of the multilayer body illustrated in FIG. 15;

FIG. 17 is a sectional view of the element body illustrated in FIG. 14 taken along line B-B;

FIG. 18 is a perspective view schematically illustrating an example of a multilayer coil component according to a second embodiment of the present disclosure;

FIG. 19 is a perspective view schematically illustrating an example of an element body that is included in the multilayer coil component illustrated in FIG. 18;

FIG. 20 is a perspective view schematically illustrating an example of a multilayer body that is prepared for fabricating the element body illustrated in FIG. 19;

FIG. 21 is an exploded perspective view of the multilayer body illustrated in FIG. 20;

FIG. 22 is a sectional view of the element body illustrated in FIG. 19 taken along line C-C;

FIG. 23 is a perspective view schematically illustrating another example of the element body that is included in the multilayer coil component illustrated in FIG. 18;

FIG. 24 is a perspective view schematically illustrating an example of a multilayer body that is prepared for fabricating the element body illustrated in FIG. 23;

FIG. 25 is an exploded perspective view of the multilayer body illustrated in FIG. 24; and

FIG. 26 is a sectional view of the element body illustrated in FIG. 23 taken along line D-D.

### DETAILED DESCRIPTION

A multilayer coil component according to preferred embodiments of the present disclosure will be described below.

However, the present disclosure is not limited to the following embodiments, and modifications may be suitably made within the gist of the present disclosure. Note that a configuration that is obtained by combining two or more desirable individual configurations that will be described below is also included in the scope of the present disclosure.

The embodiments that will be described below are examples, and it is obvious that the configurations according to the different embodiments may be partially replaced with one another or may be combined with one another. In a second embodiment and the subsequent embodiments, descriptions of matters that are common to a first embodiment will be omitted, and only differences will be described. In particular, similar advantageous effects obtained with similar configurations will not be described in every embodiment.

### First Embodiment

In a multilayer coil component according to the first embodiment of the present disclosure, a lamination direction is perpendicular to a direction in which a mounting surface extends.

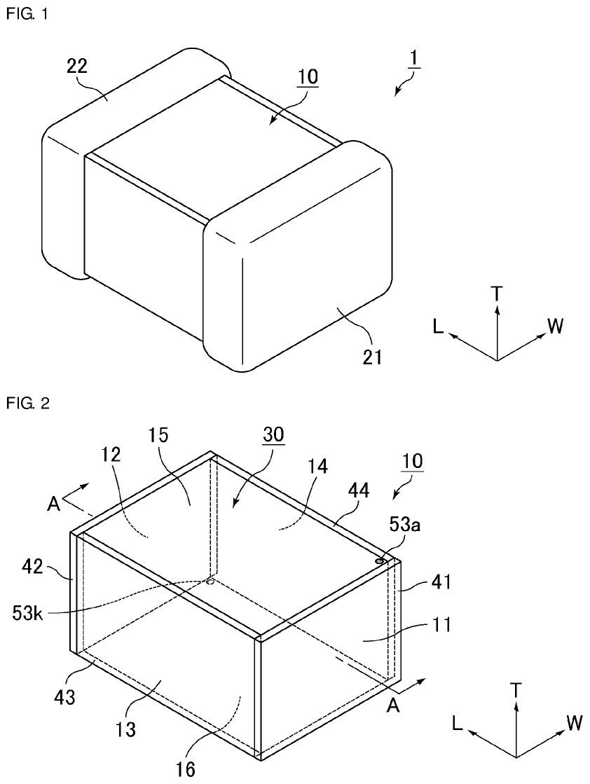

FIG. 1 is a perspective view schematically illustrating an example of the multilayer coil component according to the first embodiment of the present disclosure.

A multilayer coil component 1 that is illustrated in FIG. 1 includes an element body 10, a first outer electrode 21, and a second outer electrode 22, the first outer electrode 21 and the second outer electrode 22 being provided on the outer surfaces of the element body 10. Although the configuration of the element body 10 will be described later, the element body 10 includes a plurality of insulating layers that are laminated together, and a coil is embedded in the element body 10.

In the multilayer coil component 1 and the element body 10, which are illustrated in FIG. 1, a length direction, a width direction, and a height direction respectively correspond to an L direction, a W direction, and a T direction in FIG. 1. Here, the length direction (L direction), the width direction (W direction), and the height direction (T direction) are perpendicular to one another.

FIG. 2 is a perspective view schematically illustrating an example of the element body that is included in the multilayer coil component illustrated in FIG. 1.

As illustrated in FIG. 2, the element body 10 has a rectangular parallelepiped shape or a substantially rectangular parallelepiped shape and has a first end surface 11, a second end surface 12, a first side surface 13, a second side surface 14, a first main surface 15, and a second main surface 16. The first end surface 11 and the second end surface 12 oppose each other in the length direction (L direction). The first side surface 13 and the second side surface 14 oppose each other in the width direction (W direction). The first main surface 15 and the second main surface 16 oppose each other in the height direction (T direction).

It is preferable that corner portions and ridge line portions of the element body 10 be rounded. Each of the corner portions is a portion at which three surfaces of the element body 10 intersect one another, and each of the ridge line portions is a portion at which two surfaces of the element body 10 intersect each other.

In FIG. 1, the first outer electrode 21 covers the entire first end surface 11 of the element body 10 and partially covers the first side surface 13, the second side surface 14, the first main surface 15, and the second main surface 16 of the element body 10. The second outer electrode 22 covers the entire second end surface 12 of the element body 10 and partially covers the first side surface 13, the second side surface 14, the first main surface 15, and the second main surface 16 of the element body 10.

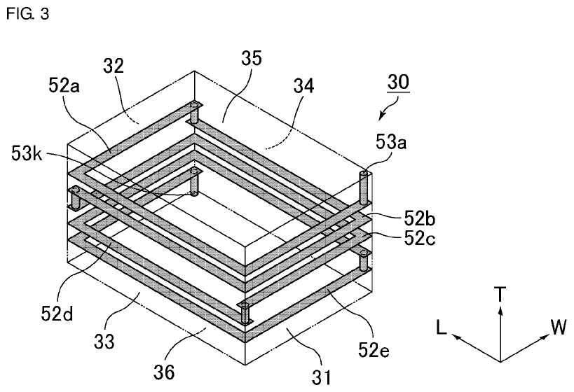

FIG. 3 is a perspective view schematically illustrating an example of a multilayer body that is prepared for fabricating the element body illustrated in FIG. 2.

As will be described later, the element body 10 illustrated in FIG. 2 is obtained by forming side-margin portions 41 and 42 respectively onto a first end surface 31 and a second end surface 32 of a multilayer body 30 that is illustrated in FIG. 3, the first end surface 31 and the second end surface 32 opposing each other in the length direction (L direction), and forming side-margin portion 43 and 44 respectively onto a first side surface 33 and a second side surface 34 of the multilayer body 30, the first side surface 33 and the second side surface 34 opposing each other in the width direction (W direction), and then firing the multilayer body 30 and the side-margin portions 41 to 44.

Note that, although the boundaries between a portion that corresponds to the multilayer body 30 and the side-margin portions 41 to 44 are clearly illustrated in the element body 10 in FIG. 2 for convenience of description, these boundaries do not necessarily appear clearly.

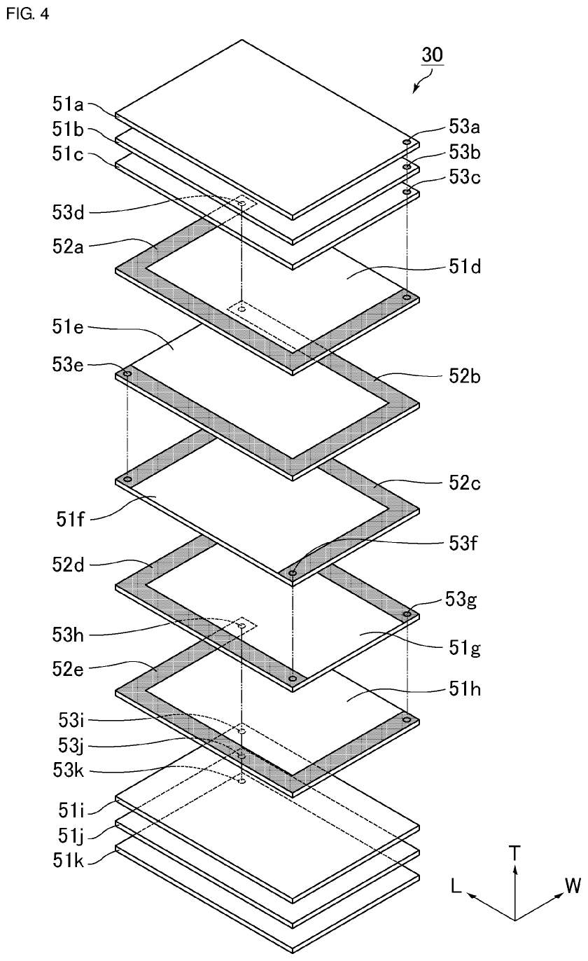

FIG. 4 is an exploded perspective view of the multilayer body illustrated in FIG. 3.

As illustrated in FIG. 4, the multilayer body 30 includes a plurality of insulating layers 51a, 51b, 51c, 51d, 51e, 51f, 51g, 51h, 51i, 51j, and 51k that are laminated together in the height direction (T direction).

Accordingly, in FIG. 1, FIG. 2, FIG. 3, and FIG. 4, the height direction (T direction) corresponds to the lamination direction.

Coil conductor layers 52a, 52b, 52c, 52d, and 52e are respectively formed on main surfaces of the insulating layers 51d, 51e, 51f, Mg, and 51h. Each of the coil conductor layers 52a to 52e has a substantially cornered U-shape and has a length of about ¾ turns.

In addition, via conductors 53a, 53b, 53c, 53d, 53e, 53f, 53g, 53h, 53i, 53j, and 53k are respectively formed in the insulating layers 51a, 51b, 51c, 51d, 51e, 51f, 51g, 51h, 51i, 51j, and 51k such that these via conductors extend through the corresponding insulating layers in the lamination direction (the T direction in FIG. 4). A land is usually provided on the main surface of each of these insulating layers so as to be connected to the corresponding via conductor.

As described above, the coil conductor layers 52a to 52e, which are arranged between the insulating layers 51a to 51k, and the via conductors 53a to 53k, which extend through the insulating layers 51a to 51k in the lamination direction, are connected to one another, so that the coil that has a coil axis extending in the T direction is formed.

As illustrated in FIG. 3, the coil conductor layers 52a to 52e are exposed at the first end surface 31, the second end surface 32, the first side surface 33, and the second side surface 34 of the multilayer body 30.

As illustrated in FIG. 2, the side-margin portion 41 is disposed so as to cover the entire first end surface 31 of the multilayer body 30, and the side-margin portion 42 is disposed so as to cover the entire second end surface 32 of the multilayer body 30, so that the coil conductor layers 52a to 52e are not exposed at the first end surface 11 or the second end surface 12 of the element body 10. Similarly, the side-margin portion 43 is disposed so as to cover the entire first side surface 33 of the multilayer body 30, and the side-margin portion 44 is disposed so as to cover the entire second side surface 34 of the multilayer body 30, so that the coil conductor layers 52a to 52e are not exposed at the first side surface 13 or the second side surface 14 of the element body 10.

As illustrated in FIG. 3, the via conductor 53a is exposed at a first main surface 35 of the multilayer body 30. As illustrated in FIG. 2, although the side-margin portions 41 and 44 are provided, the via conductor 53a is exposed at the first main surface 15 of the element body 10 and connected to the first outer electrode 21 illustrated in FIG. 1. Similarly, as illustrated in FIG. 3, the via conductor 53k is exposed at a second main surface 36 of the multilayer body 30. As illustrated in FIG. 2, although the side-margin portions 42 and 44 are provided, the via conductor 53k is exposed at the second main surface 16 of the element body 10 and connected to the second outer electrode 22 illustrated in FIG. 1. Therefore, each of the first outer electrode 21 and the second outer electrode 22 is electrically connected to the coil.

In the case where the multilayer coil component 1, which is illustrated in FIG. 1, is mounted onto a substrate, the first main surface 15 or the second main surface 16 of the element body 10 serves as the mounting surface. Thus, in the multilayer coil component 1, which is illustrated in FIG. 1, the lamination direction (T direction in FIG. 1) is perpendicular to a direction in which the mounting surface extends.

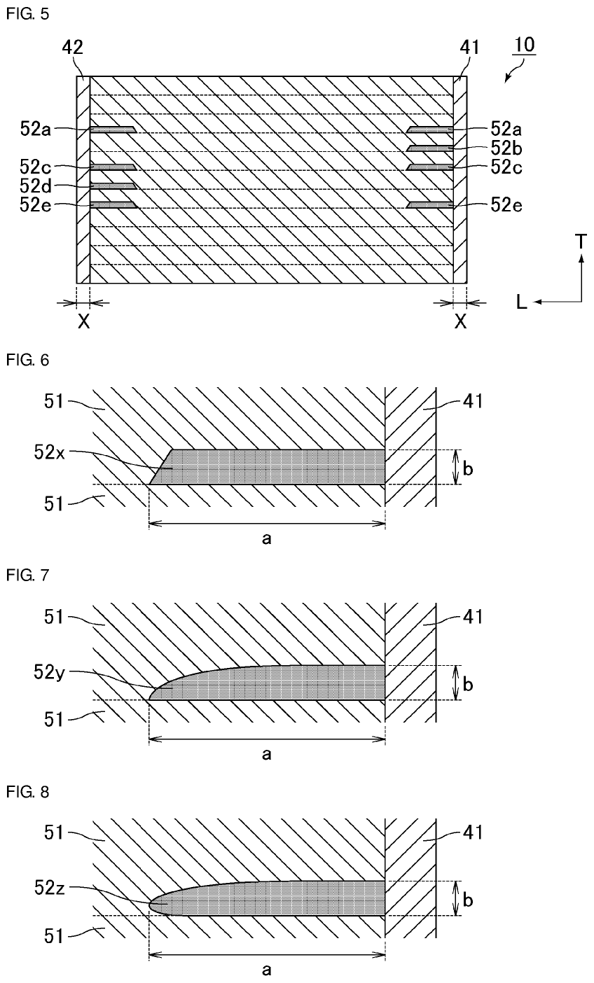

FIG. 5 is a sectional view of the element body illustrated in FIG. 2 taken along line A-A. In other words, FIG. 5 is an LT sectional view of the element body illustrated in FIG. 2.

As illustrated in FIG. 5, when viewed in cross section in the lamination direction (T direction), end surfaces of the coil conductor layers 52a to 52e that face outward of the element body 10 are substantially straight in the lamination direction (T direction). In contrast, end surfaces of the coil conductor layers 52a to 52e that face inward of the element body 10 are inclined with respect to the lamination direction (T direction).

The multilayer coil component according to the first embodiment of the present disclosure is formed in a manner that, when viewed in cross section in the lamination direction, the end surfaces of the coil conductor layers that face outward of the element body are substantially straight in the lamination direction, and the end surfaces of the coil conductor layers that face inward of the element body are inclined or bent with respect to the lamination direction.

The multilayer coil component according to the first embodiment of the present disclosure can be manufactured by a manufacturing method that will be described later. In the manufacturing method, which will be described later, the ratio of a maximum thickness b of one coil conductor layer to a maximum width a of the coil conductor layer (b/a) can be set to be large. Therefore, a direct-current resistance Rdc of the multilayer coil component can be reduced.

FIG. 6 is an enlarged cross-sectional view schematically illustrating an example of a coil conductor layer having an end surface that faces inward of the element body and that is inclined with respect to the lamination direction.

A coil conductor layer 52x that is illustrated in FIG. 6 has a substantially trapezoidal cross-sectional shape, and the bottom side of the coil conductor layer 52x that is positioned at the boundary between two of the insulating layers 51 is longer than the top side of the coil conductor layer 52x that opposes the bottom side.

FIG. 7 is an enlarged cross-sectional view schematically illustrating an example of a coil conductor layer having an end surface that faces inward of the element body and that is bent with respect to the lamination direction.

A coil conductor layer 52y that is illustrated in FIG. 7 is formed such that the width of the coil conductor layer 52y in a direction in which the main surfaces of the insulating layers 51 extend is largest at the bottom side of the coil conductor layer 52y that is positioned at the boundary between two of the insulating layers 51.

FIG. 8 is an enlarged cross-sectional view schematically illustrating another example of a coil conductor layer having an end surface that faces inward of the element body and that is bent with respect to the lamination direction.

A coil conductor layer 52z that is illustrated in FIG. 8 is formed such that the width of the coil conductor layer 52z in the direction in which the main surfaces of the insulating layers 51 extend is largest at a position other than the bottom side of the coil conductor layer 52z that is positioned at the boundary between two of the insulating layers 51.

In the multilayer coil component according to the first embodiment of the present disclosure, when the maximum width of one of the coil conductor layers in the direction in which the main surfaces of the insulating layers extend is a, and the maximum thickness of the coil conductor layer in the lamination direction is b (see FIG. 6, FIG. 7, and FIG. 8), it is preferable that the ratio of b to a (b/a) be about 0.5 or larger and about 2.0 or smaller (i.e., from about 0.5 to about 2.0), and more preferably, about 0.8 or larger and about 2.0 or smaller (i.e., from about 0.8 to about 2.0).

By increasing the ratio of b to a (b/a), the direct-current resistance Rdc of the multilayer coil component can be reduced.

In the multilayer coil component according to the first embodiment of the present disclosure, it is preferable that the maximum thickness of one of the coil conductor layers in the lamination direction be about 25 μm or larger and about 100 μm or smaller (i.e., from about 25 μm to about 100 μm), and more preferably, about 40 μm or larger and about 100 μm or smaller (i.e., from about 40 μm to about 100 μm).

By increasing the thickness of one of the coil conductor layers, the direct-current resistance Rdc of the multilayer coil component can be reduced.

In the multilayer coil component according to the first embodiment of the present disclosure, it is preferable that the maximum width of one of the coil conductor layers in the direction in which the main surfaces of the insulating layers extend be about 12.5 μm or larger and about 200 μm or smaller (i.e., from about 12.5 μm to about 200 μm), and more preferably, about 20 μm or larger and about 100 μm or smaller (i.e., from about 20 μm to about 100 μm).

The maximum width and the maximum thickness of one of the coil conductor layers are measured by a method that will be described below.

A sample is placed so as to stand vertically, and a resin is cured so as to surround the sample. In this case, an LT side surface of the sample is exposed.

The sample is ground by using a grinder, and the grinding is finished when about one-half of the depth of the sample in the W direction has been ground, so that the LT cross section of the sample is exposed.

In order to eliminate uneven grinding of the coil conductor layer due to the grinding, after the grinding has been finished, the ground surface is processed by ion milling (using ion milling system IM4000 manufactured by Hitachi High-Technologies Corporation).

An image of the coil conductor layer is captured by a scanning electron microscope (SEM), and the width and the thickness of the coil conductor layer are measured from the captured image. The measurement is performed at two positions in a center region of the coil conductor layer. The average of the widths measured at the two positions and the average of the thicknesses measured at the two positions are calculated, and these averages are defined as the maximum width and the maximum thickness of the coil conductor layer.

In the multilayer coil component according to the first embodiment of the present disclosure, it is preferable that the thickness (the length indicated by X in FIG. 5) of each of the side-margin portions, which are positioned between the end surfaces of the plurality of coil conductor layers that face outward of the element body and one of the outer surfaces of the element body, be about 5 μm or larger and about 20 μm or smaller (i.e., from about 5 μm to about 20 μm).

By forming the side-margin portions so as to be thin, the multilayer coil component can be reduced in size.

The thickness of each side-margin portion is measured by a method that will be described below.

A sample is placed so as to stand vertically, and a resin is cured so as to surround the sample. In this case, an LT side surface of the sample is exposed.

The sample is ground by using a grinder, and the grinding is finished when about one-half of the depth of the sample in the W direction has been ground, so that the LT cross section of the sample is exposed.

An image of each side-margin portion is captured by a scanning electron microscope (SEM), and the thickness of each of the side-margin portions is measured from the captured image. The measurement is performed on two portions of each of the side-margin portions that are formed on end surfaces of the sample that oppose each other. The average of the thicknesses of the two portions is calculated, and the average is defined as the thickness of the side-margin portion.

In the multilayer coil component according to the first embodiment of the present disclosure, two or more coil conductor layers may be provided on one insulating layer such that the two or more coil conductor layers are superposed with each other.

In this case, the total thickness of the coil conductor layers is large, and thus, the direct-current resistance Rdc of the multilayer coil component can be further reduced.

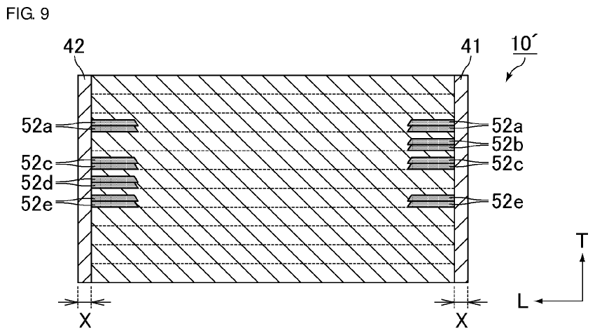

FIG. 9 is a sectional view schematically illustrating a case where two coil conductor layers are provided on one insulating layer such that the two coil conductor layers are superposed with each other.

Although FIG. 9 illustrates a case where, in an element body 10′, some of insulating layers are each provided with two coil conductor layers such that the two coil conductor layers are superposed with each other on the insulating layer, there may be an insulating layer that is provided with one coil conductor layer formed thereon. In addition, the number of coil conductor layers provided on each of these insulating layers may be the same or may be different from one another.

As an example of the method of manufacturing the multilayer coil component according to the first embodiment of the present disclosure, a method of manufacturing a multilayer coil component that includes the element body illustrated in FIG. 2 will be described below.

First, insulating sheets that are to be insulating layers are prepared. For example, magnetic sheets that are made of Ni—Zn—Cu ferrite are prepared.

Next, via conductors are formed at predetermined positions in the insulating sheets. More specifically, laser is radiated onto predetermined portions of the insulating sheets so as to form via holes, and the via holes are filled with an electrically conductive paste such as a silver (Ag) paste.

In addition, coil-conductor-layer patterns are formed onto the specified insulating sheets by screen printing or the like using an electrically conductive paste such as an Ag paste.

In this case, the coil-conductor-layer patterns are printed with the electrically conductive paste onto the insulating sheets such that coil conductor layers of adjacent multilayer bodies are continuous with each other or such that coil conductor layers of adjacent multilayer bodies are spaced apart from each other. In both cases, the coil-conductor-layer patterns each of which has a width larger than the width of a coil conductor layer required for one multilayer coil component are printed with the electrically conductive paste.

Note that it is preferable to apply an insulating paste such as a ferrite paste to regions in which the coil-conductor-layer patterns are not formed such that the insulating paste has a thickness that is substantially the same as the thickness of each of the coil-conductor-layer patterns. In this case, the difference in level between the portions on which the coil-conductor-layer patterns are formed and the portions on which the coil-conductor-layer patterns are not formed can be eliminated.

In addition, the printing of the coil-conductor-layer patterns and the application of the insulating paste for eliminating the level difference may be repeatedly performed so as to obtain the shape illustrated in FIG. 9.

After that, the insulating sheets in or on which the via conductors and/or the coil-conductor-layer patterns have been formed are laminated together, so that a mother multilayer body is obtained. More specifically, it is preferable that the insulating sheets be stacked on top of one another and be bonded together by being heated and pressurized.

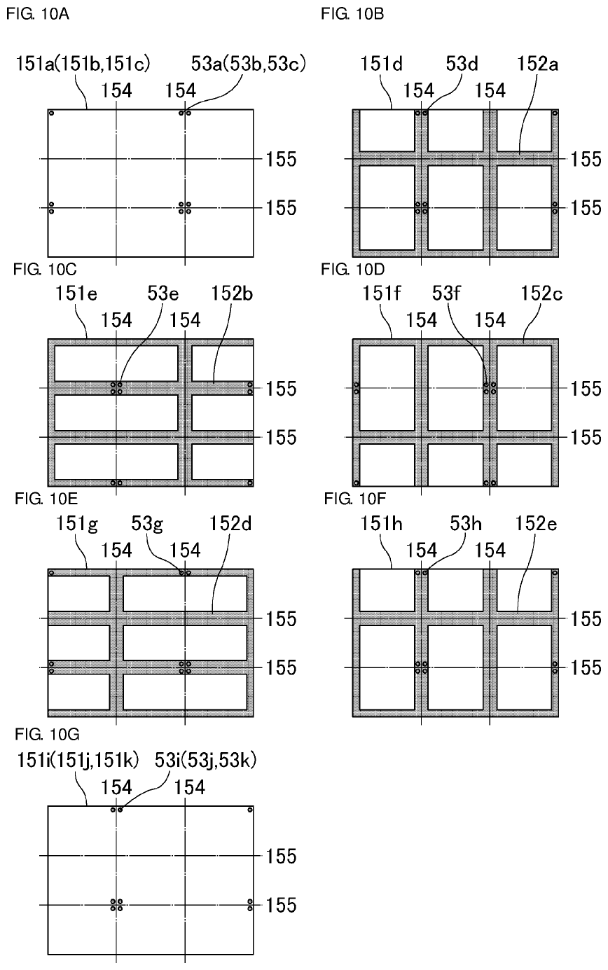

FIG. 10A, FIG. 10B, FIG. 10C, FIG. 10D, FIG. 10E, FIG. 10F, and FIG. 10G are plan views schematically illustrating examples of insulating sheets that are laminated together in order to obtain a mother multilayer body.

FIG. 10A to FIG. 10G each illustrate cutting lines 154 and 155 along which a mother multilayer body that is obtained is to be cut.

The via conductors 53a, 53b, 53c, 53d, 53e, 53f, 53g, 53h, 53i, 53j, and 53k are respectively formed in insulating sheets 151a, 151b, 151c, 151d, 151e, 151f, 151g, 151h, 151i, 151j, and 151k that are to be the insulating layers 51a, 51b, 51c, 51d, 51e, 51f, 51g, 51h, 51i, 51j, and 51k.

In addition, coil-conductor-layer patterns 152a, 152b, 152c, 152d, and 152e are respectively formed on the insulating sheets 151d, 151e, 151f, 151g, and 151h that are to be the insulating layers 51d, 51e, 51f, 51g, and 51h. The coil-conductor-layer patterns 152a to 152e are respectively provided on the insulating sheets 151d to 151h such that coil conductor layers of adjacent multilayer bodies are continuous with each other.

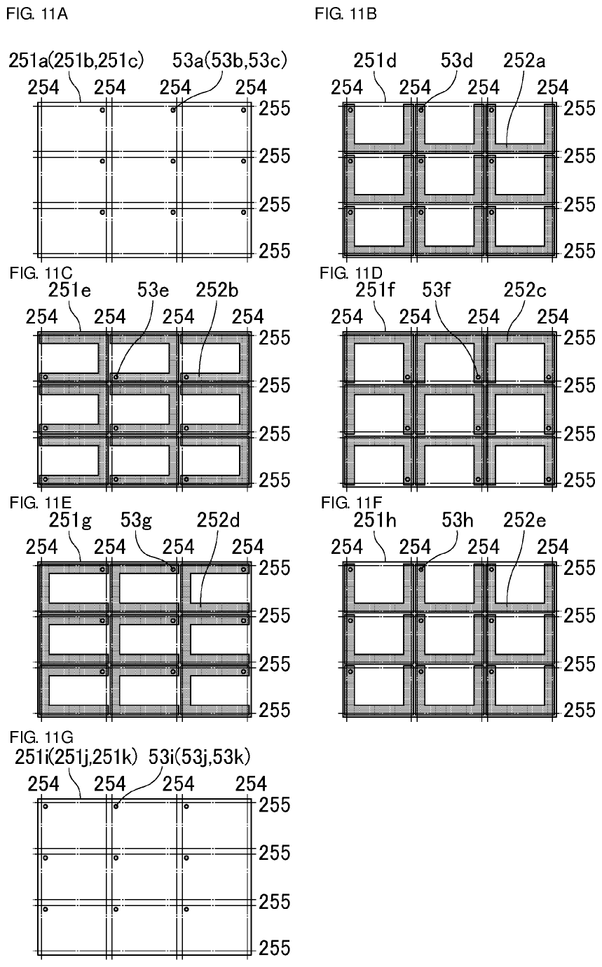

FIG. 11A, FIG. 11B, FIG. 11C, FIG. 11D, FIG. 11E, FIG. 11F, and FIG. 11G are plan views schematically illustrating other examples of insulating sheets that are laminated together in order to obtain a mother multilayer body.

FIG. 11A to FIG. 11G each illustrate cutting lines 254 and 255 along which a mother multilayer body that is obtained is to be cut.

The via conductors 53a, 53b, 53c, 53d, 53e, 53f, 53g, 53h, 53i, 53j, and 53k are respectively formed in insulating sheets 251a, 251b, 251c, 251d, 251e, 251f, 251g, 251h, 251i, 251j, and 251k that are to be the insulating layers 51a, 51b, 51c, 51d, 51e, 51f, 51g, 51h, 51i, 51j, and 51k.

In addition, coil-conductor-layer patterns 252a, 252b, 252c, 252d, and 252e are respectively formed on the insulating sheets 251d, 251e, 251f, 251g, and 251h that are to be the insulating layers 51d, 51e, 51f, 51g, and 51h. The coil-conductor-layer patterns 252a to 252e are respectively provided on the insulating sheets 251d to 251h such that coil conductor layers of adjacent multilayer bodies are spaced apart from each other.

As a result of laminating the above-mentioned insulating sheets together, the mother multilayer body that includes the laminated plurality of insulating sheets, the plurality of coil-conductor-layer patterns provided between the insulating sheets, and one or more via conductors extending through the insulating sheets in the lamination direction is obtained.

The obtained mother multilayer body is cut by a dicer or the like and divided into a plurality of green multilayer bodies.

For example, by cutting the mother multilayer body along the cutting lines 154 and 155 illustrated in FIG. 10 or along the cutting lines 254 and 255 illustrated in FIG. 11, the mother multilayer body is divided into nine multilayer bodies. In practice, the mother multilayer body is divided into a larger number of multilayer bodies.

As illustrated in FIG. 3 and FIG. 4, in each of the multilayer bodies 30, the plurality of coil conductor layers 52a to 52e provided between the plurality of insulating layers 51a to 51k, which have been laminated together, and the one or more via conductors 53a to 53k that extend through the insulating layers 51a to 51k in the lamination direction are connected to one another, so that a coil is formed. The first end surface 31 and the second end surface 32 of the multilayer body 30 are surfaces that are formed as a result of performing the cutting along the cutting lines 154 or 254, and the first side surface 33 and the second side surface 34 of the multilayer body 30 are surfaces that are formed as a result of performing the cutting along the cutting lines 155 or 255. The coil conductor layers 52a to 52e are exposed at the first end surface 31, the second end surface 32, the first side surface 33, or the second side surface 34 of the multilayer body 30. In addition, the via conductor 53a is exposed at the first main surface 35 of the multilayer body 30, and the via conductor 53k is exposed at the second main surface 36 of the multilayer body 30.

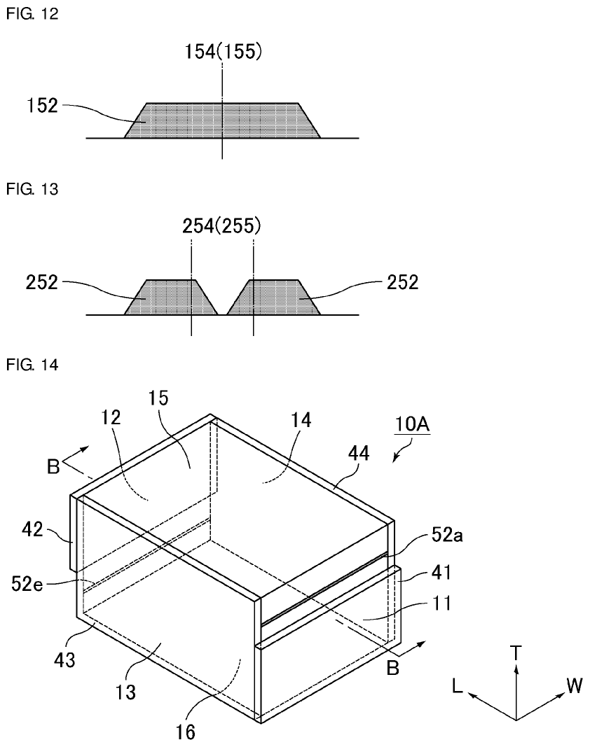

FIG. 12 is an enlarged cross-sectional view schematically illustrating an example of a coil-conductor-layer pattern that is to be cut. FIG. 13 is an enlarged cross-sectional view schematically illustrating another example of a coil-conductor-layer pattern that is to be cut.

As illustrated in FIG. 12 and FIG. 13, when a coil-conductor-layer pattern 152 or coil-conductor-layer patterns 252 are formed by screen printing, the cross section of each of the coil-conductor-layer patterns is a shape resembling a substantially trapezoidal shape.

The thickness of a coil-conductor-layer pattern that is printed with a paste can be increased with the increasing width (the width in a direction in which a main surface of an insulating layer extends) of the coil-conductor-layer pattern. Thus, as illustrated in FIG. 12 or FIG. 13, the coil-conductor-layer pattern 152 or each of the coil-conductor-layer patterns 252 is printed with the electrically conductive paste so as to have a width larger than the width of one multilayer coil component, and the coil-conductor-layer pattern is cut along the cutting lines 154 (155) or the cutting lines 254 (255), so that the coil conductor layer that is illustrated in FIG. 6 and the like and in which the ratio of b to a (b/a) is large can be formed. As a result, the direct-current resistance Rdc of the multilayer coil component can be reduced.

In FIG. 12, although a mother multilayer body is divided by performing a cutting operation once along the cutting lines 154, for example, the mother multilayer body may be divided by performing a cutting operation twice along the cutting lines 254 illustrated in FIG. 13. Similarly, in FIG. 12, although the mother multilayer body is divided by performing a cutting operation once along the cutting lines 155, for example, the mother multilayer body may be divided by performing a cutting operation twice along the cutting lines 255 illustrated in FIG. 13. The number of times the cutting operation along the cutting lines 154 is performed may be the same as or different from the number of times the cutting operation along the cutting lines 155 is performed. From the standpoint of reducing the number of times the cutting operation is performed and reducing waste of material, it is preferable that the mother multilayer body be divided by performing a cutting operation once along the cutting lines 154 and performing a cutting operation once along the cutting lines 155.

In addition, although FIG. 12 illustrates a case where the cross-sectional shape of a coil-conductor-layer pattern that is formed such that coil conductor layers of adjacent multilayer bodies are continuous with each other is the shape of one substantial trapezoid, the cross-sectional shape of the coil-conductor-layer pattern may be a shape resembling two substantial trapezoids being in contact with each other or a shape resembling two substantial trapezoids overlapping each other.

In FIG. 13, although the mother multilayer body is divided by performing a cutting operation twice along the cutting lines 254, for example, the mother multilayer body may be divided by performing a cutting operation once using a dicer or the like that has a blade width equal to the distance between the cutting lines 254 illustrated in FIG. 13. Similarly, in FIG. 13, although the mother multilayer body is divided by performing a cutting operation twice along the cutting lines 255, for example, the mother multilayer body may be divided by performing a cutting operation once using a dicer or the like that has a blade width equal to the distance between the cutting lines 255 illustrated in FIG. 13. The number of times the cutting operation along the cutting lines 254 is performed may be the same as or different from the number of times the cutting operation along the cutting lines 255 is performed.

After the mother multilayer body has been cut, side-margin portions are formed by using an insulating material onto cut surfaces of each of the multilayer bodies at which the coil conductor layers are exposed. Each of the side-margin portions can be formed by, for example, attaching an insulating sheet or applying an insulating paste to a corresponding one of the cut surfaces.

For example, after an adhesive has been applied to the cut surfaces of the multilayer body, at which the coil conductor layers have been exposed, the cut surfaces are each pressed against a magnetic sheet that has been heated, and then the magnetic sheet is cut along the outer peripheral edges of the cut surfaces, so that the side-margin portions are formed.

The insulating material that is included in the insulating sheet or the insulating paste may be the same as or different from the material included in the insulating layers.

Subsequently, the multilayer body on which the side-margin portions have been formed is fired, so that an element body is obtained. Although the firing temperature depends on a ceramic material and a metal material that are included in the multilayer body, the firing temperature is, for example, about 860° C. or greater and about 920° C. or less.

It is preferable to perform barrel polishing on the element body that has been fired such that the corner portions and the ridge line portions of the element body are rounded.

A first outer electrode and a second outer electrode each of which is electrically connected to a coil are formed on outer surfaces of the element body.

For example, base electrodes are formed by applying an electrically conductive paste that contains Ag and glass to end surfaces of the element body and baking the electrically conductive paste. After that, a nickel (Ni) coating film and a tin (Sn) coating film are sequentially formed onto each of the base electrodes by electrolytic plating, so that the outer electrodes are formed.

In the manner described above, the multilayer coil component including the element body that is illustrated in FIG. 2 is obtained.

FIG. 14 is a perspective view schematically illustrating another example of the element body that is included in the multilayer coil component illustrated in FIG. 1.

Similar to the element body 10 illustrated in FIG. 2, an element body 10A that is illustrated in FIG. 14 has the first end surface 11, the second end surface 12, the first side surface 13, the second side surface 14, the first main surface 15, and the second main surface 16, the first end surface 11 and the second end surface 12 opposing each other in the length direction (L direction), the first side surface 13 and the second side surface 14 opposing each other in the width direction (W direction), and the first main surface 15 and the second main surface 16 opposing each other in the height direction (T direction). It is preferable that corner portions and ridge line portions of the element body 10A be rounded.

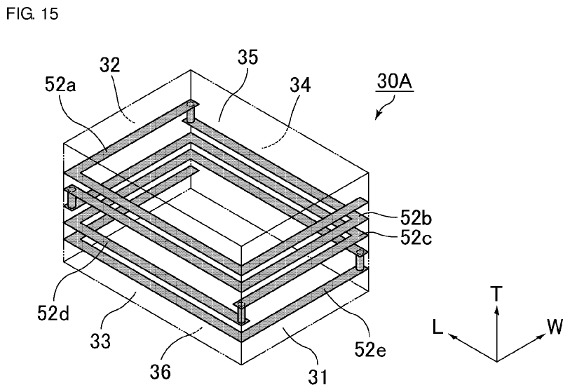

FIG. 15 is a perspective view schematically illustrating an example of a multilayer body that is prepared for fabricating the element body illustrated in FIG. 14.

The element body 10A illustrated in FIG. 14 is obtained by forming the side-margin portions 41 and 42 respectively onto the first end surface 31 and the second end surface 32 of a multilayer body 30A that is illustrated in FIG. 15 that oppose each other in the length direction (L direction) and forming the side-margin portions 43 and 44 respectively onto the first side surface 33 and the second side surface 34 of the multilayer body 30A that oppose each other in the width direction (W direction).

Note that, similar to the element body 10 illustrated in FIG. 2, in the element body 10A illustrated in FIG. 14, the boundaries between a portion that corresponds to the multilayer body 30A and the side-margin portions 41 to 44 do not necessarily appear clearly.

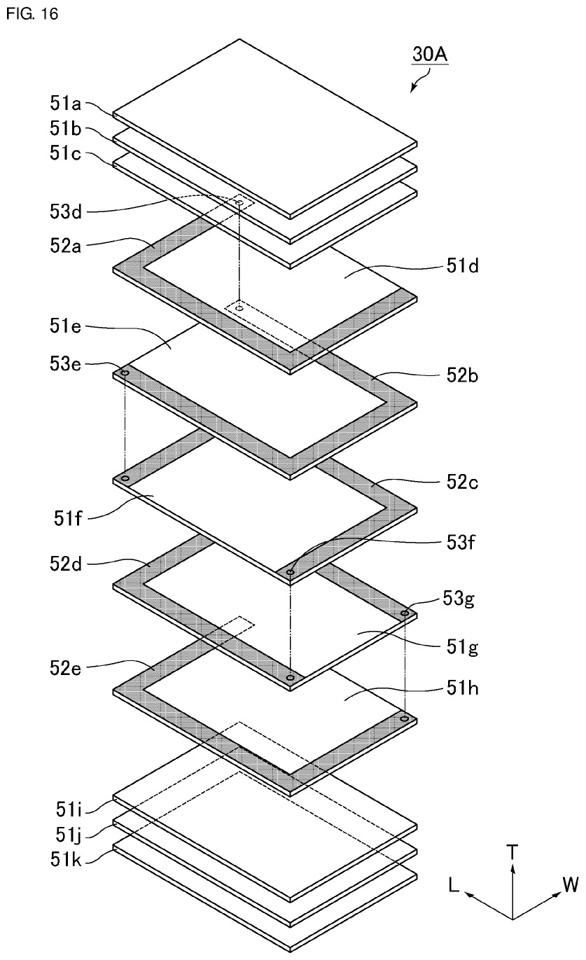

FIG. 16 is an exploded perspective view of the multilayer body illustrated in FIG. 15.

As illustrated in FIG. 16, the multilayer body 30A includes the plurality of insulating layers 51a, 51b, 51c, 51d, 51e, 51f, 51g, 51h, 51i, 51j, and 51k that are laminated together in the height direction (T direction).

Accordingly, in FIG. 1, FIG. 14, FIG. 15, and FIG. 16, the height direction (T direction) corresponds to the lamination direction.

The coil conductor layers 52a, 52b, 52c, 52d, and 52e are respectively formed on the main surfaces of the insulating layers 51d, 51e, 51f, 51g, and 51h. Each of the coil conductor layers 52a to 52e has a substantially cornered U-shape and has a length of about ¾ turns.

In addition, the via conductors 53d, 53e, 53f, and 53g are respectively formed in the insulating layers 51d, 51e, 51f, and 51g such that these via conductors extend through the corresponding insulating layers in the lamination direction (the T direction in FIG. 16). A land is usually provided on the main surface of each of these insulating layers so as to be connected to the corresponding via conductor.

As described above, the coil conductor layers 52a to 52e, which are arranged between the insulating layers 51a to 51k, and the via conductors 53d to 53g that extend through the corresponding insulating layers 51d to 51g in the lamination direction are connected to one another, so that the coil that has a coil axis extending in the T direction is formed.

As illustrated in FIG. 15, the coil conductor layers 52a to 52e are exposed at the first end surface 31, the second end surface 32, the first side surface 33, and the second side surface 34 of the multilayer body 30A.

As illustrated in FIG. 14, the side-margin portion 41 is disposed so as to cover a portion of the first end surface 31 of the multilayer body 30A, and thus, the coil conductor layer 52a is exposed at the first end surface 11 of the element body 10A and connected to the first outer electrode 21 illustrated in FIG. 1. In addition, the side-margin portion 42 is disposed so as to cover a portion of the second end surface 32 of the multilayer body 30A, and thus, the coil conductor layer 52e is exposed at the second end surface 12 of the element body 10A and connected to the second outer electrode 22 illustrated in FIG. 1. Therefore, the first outer electrode 21 and the second outer electrode 22 are each electrically connected to the coil.

In contrast, the side-margin portion 43 is disposed so as to cover the entire first side surface 33 of the multilayer body 30A, and the side-margin portion 44 is disposed so as to cover the entire second side surface 34 of the multilayer body 30A, so that the coil conductor layers 52a to 52e are not exposed at the first side surface 13 or the second side surface 14 of the element body 10A.

The element body 10A illustrated in FIG. 14 has the same configuration as the element body 10 illustrated in FIG. 2 except that the coil conductor layer 52a is connected to the first outer electrode 21 and that the coil conductor layer 52e is connected to the second outer electrode 22.

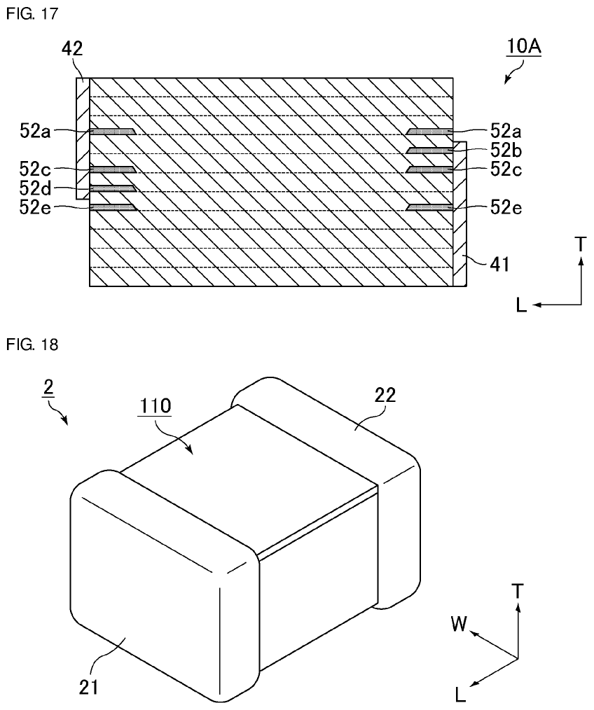

FIG. 17 is a sectional view of the element body illustrated in FIG. 14 taken along line B-B. In other words, FIG. 17 is an LT sectional view of the element body illustrated in FIG. 14.

Similar to FIG. 5, when viewed in cross section in the lamination direction (T direction), the end surfaces of the coil conductor layers 52a to 52e that face outward of the element body 10A are substantially straight in the lamination direction (T direction). In contrast, the end surfaces of the coil conductor layers 52a to 52e that face inward of the element body 10A are inclined with respect to the lamination direction (T direction).

Each of the end surfaces of the coil conductor layers 52a to 52e that face inward of the element body 10A may be inclined with respect to the lamination direction as illustrated in FIG. 6 or may be bent with respect to the lamination direction as illustrated in FIG. 7 or FIG. 8.

As illustrated in FIG. 9, two coil conductor layers may be provided on one insulating layer such that the two coil conductor layers are superposed with each other, or two or more coil conductor layers may be provided on one insulating layer such that the two or more coil conductor layers are superposed with one another.

In a method of manufacturing a multilayer coil component that includes the element body 10A illustrated in FIG. 14, although the positions at which the via conductors are to be formed, the positions at which the side-margin portions are to be formed, and so forth are slightly different from those in the method of manufacturing a multilayer coil component that includes the element body 10 illustrated in FIG. 2, this method is similar to the method of manufacturing a multilayer coil component that includes the element body 10 illustrated in FIG. 2, and thus, detailed description thereof will be omitted.

### Second Embodiment

In a multilayer coil component according to a second embodiment of the present disclosure, the lamination direction is the same as a direction in which a mounting surface extends.

FIG. 18 is a perspective view schematically illustrating an example of a multilayer coil component according to the second embodiment of the present disclosure.

A multilayer coil component 2 that is illustrated in FIG. 18 includes an element body 110 and the first and second outer electrodes 21 and 22 that are provided on outer surfaces of the element body 110. Although the configuration of the element body 110 will be described later, the element body 110 includes a plurality of insulating layers that are laminated together, and a coil is embedded in the element body 110.

In the multilayer coil component 2 and the element body 110, which are illustrated in FIG. 18, the length direction, the width direction, and the height direction respectively correspond to the L direction, the W direction, and the T direction in FIG. 18. Here, the length direction (L direction), the width direction (W direction), and the height direction (T direction) are perpendicular to one another.

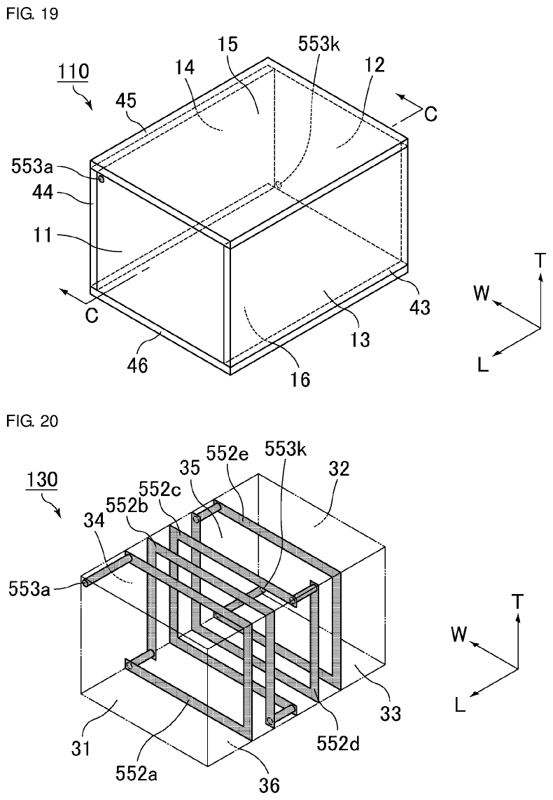

FIG. 19 is a perspective view schematically illustrating an example of an element body that is included in the multilayer coil component illustrated in FIG. 18.

As illustrated in FIG. 19, the element body 110 has a rectangular parallelepiped shape or a substantially rectangular parallelepiped shape and has the first end surface 11, the second end surface 12, the first side surface 13, the second side surface 14, the first main surface 15, and the second main surface 16. The first end surface 11 and the second end surface 12 oppose each other in the length direction (L direction). The first side surface 13 and the second side surface 14 oppose each other in the width direction (W direction). The first main surface 15 and the second main surface 16 oppose each other in the height direction (T direction). It is preferable that corner portions and ridge line portions of the element body 110 be rounded.

In FIG. 18, the first outer electrode 21 covers the entire first end surface 11 of the element body 110 and partially covers the first side surface 13, the second side surface 14, the first main surface 15, and the second main surface 16 of the element body 110. The second outer electrode 22 covers the entire second end surface 12 of the element body 110 and partially covers the first side surface 13, the second side surface 14, the first main surface 15, and the second main surface 16 of the element body 110.

FIG. 20 is a perspective view schematically illustrating an example of a multilayer body that is prepared for fabricating the element body illustrated in FIG. 19.

As will be described later, the element body 110 illustrated in FIG. 19 is obtained by forming the side-margin portion 43 and 44 respectively onto the first side surface 33 and the second side surface 34 of a multilayer body 130 that is illustrated in FIG. 20, the first side surface 33 and the second side surface 34 opposing each other in the width direction (W direction), and forming side-margin portions 45 and 46 respectively onto the first main surface 35 and the second main surface 36 of the multilayer body 130, the first main surface 35 and the second main surface 36 opposing each other in the height direction (T direction), and then firing the multilayer body 130 and the side-margin portions 43 to 46.

Note that, although the boundaries between a portion that corresponds to the multilayer body 130 and the side-margin portions 43 to 46 are clearly illustrated in the element body 110 in FIG. 19 for convenience of description, these boundaries do not necessarily appear clearly.

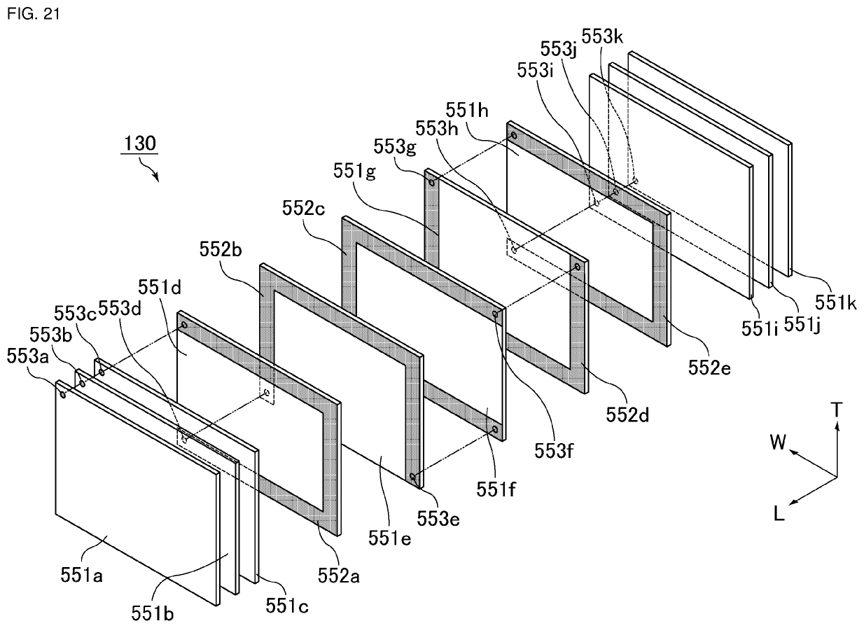

FIG. 21 is an exploded perspective view of the multilayer body illustrated in FIG. 20.

As illustrated in FIG. 21, the multilayer body 130 includes a plurality of insulating layers 551a, 551b, 551c, 551d, 551e, 551f, 551g, 551h, 551i, 551j, and 551k that are laminated together in the length direction (L direction).

Accordingly, in FIG. 18, FIG. 19, FIG. 20, and FIG. 21, the length direction (L direction) corresponds to the lamination direction.

Coil conductor layers 552a, 552b, 552c, 552d, and 552e are respectively formed on main surfaces of the insulating layers 551d, 551e, 551f, 551g, and 551h. Each of the coil conductor layers 552a to 552e has a substantially cornered U-shape and has a length of about ¾ turns.

In addition, via conductors 553a, 553b, 553c, 553d, 553e, 553f, 553g, 553h, 553i, 553j, and 553k are respectively formed in the insulating layers 551a, 551b, 551c, 551d, 551e, 551f, 551g, 551h, 551i, 551j, and 551k such that these via conductors extend through the corresponding insulating layers in the lamination direction (the L direction in FIG. 21). A land is usually provided on the main surface of each of these insulating layers so as to be connected to the corresponding via conductor.

As described above, the coil conductor layers 552a to 552e, which are arranged between the insulating layers 551a to 551k, and the via conductors 553a to 553k, which extend through the insulating layers 551a to 551k in the lamination direction, are connected to one another, so that the coil that has a coil axis extending in the L direction is formed.

As illustrated in FIG. 20, the coil conductor layers 552a to 552e are exposed at the first side surface 33, the second side surface 34, the first main surface 35, and the second main surface 36 of the multilayer body 130.

As illustrated in FIG. 19, the side-margin portion 43 is disposed so as to cover the entire first side surface 33 of the multilayer body 130, and the side-margin portion 44 is disposed so as to cover the entire second side surface 34 of the multilayer body 130, so that the coil conductor layers 552a to 552e are not exposed at the first side surface 13 or the second side surface 14 of the element body 110. Similarly, the side-margin portion 45 is disposed so as to cover the entire first main surface 35 of the multilayer body 130, and the side-margin portion 46 is disposed so as to cover the entire second main surface 36 of the multilayer body 130, so that the coil conductor layers 552a to 552e are not exposed at the first main surface 15 or the second main surface 16 of the element body 110.

As illustrated in FIG. 20, the via conductor 553a is exposed at the first end surface 31 of the multilayer body 130. As illustrated in FIG. 19, although the side-margin portions 44 and 45 are provided, the via conductor 553a is exposed at the first end surface 11 of the element body 110 and connected to the first outer electrode 21 illustrated in FIG. 18. Similarly, as illustrated in FIG. 20, the via conductor 553k is exposed at the second end surface 32 of the multilayer body 130. As illustrated in FIG. 19, although the side-margin portions 44 and 46 are provided, the via conductor 553k is exposed at the second end surface 12 of the element body 110 and connected to the second outer electrode 22 illustrated in FIG. 18. Therefore, the first outer electrode 21 and the second outer electrode 22 are each electrically connected to the coil.

In the case where the multilayer coil component 2, which is illustrated in FIG. 18, is mounted onto a substrate, the first main surface 15 or the second main surface 16 of the element body 110 serves as the mounting surface. Thus, in the multilayer coil component 2, which is illustrated in FIG. 18, the lamination direction (the L direction in FIG. 18) is the same as a direction in which the mounting surface extends.

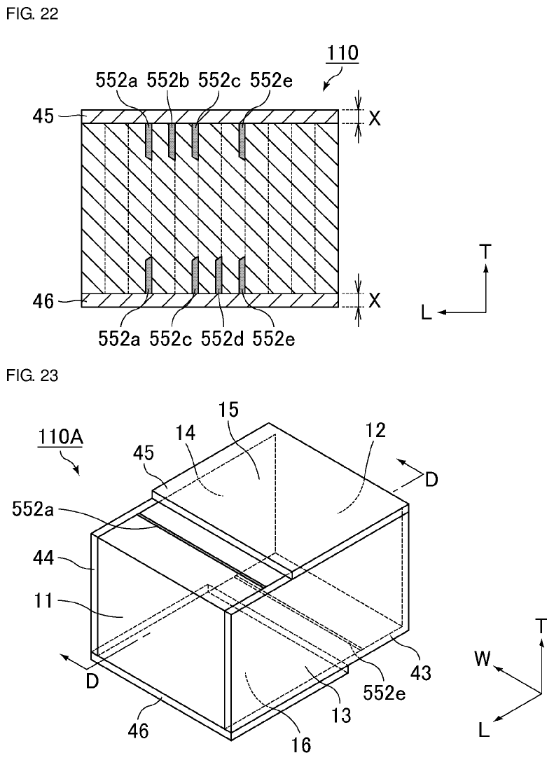

FIG. 22 is a sectional view of the element body illustrated in FIG. 19 taken along line C-C. In other words, FIG. 22 is an LT sectional view of the element body illustrated in FIG. 19.

As illustrated in FIG. 22, when viewed in cross section in the lamination direction (L direction), end surfaces of the coil conductor layers 552a to 552e that face outward of the element body 110 are substantially straight in the lamination direction (L direction). In contrast, end surfaces of the coil conductor layers 552a to 552e that face inward of the element body 110 are inclined with respect to the lamination direction (L direction).

FIG. 23 is a perspective view schematically illustrating another example of the element body that is included in the multilayer coil component illustrated in FIG. 18.

Similar to the element body 110 illustrated in FIG. 19, an element body 110A that is illustrated in FIG. 23 has the first end surface 11, the second end surface 12, the first side surface 13, the second side surface 14, the first main surface 15, and the second main surface 16, the first end surface 11 and the second end surface 12 opposing each other in the length direction (L direction), the first side surface 13 and the second side surface 14 opposing each other in the width direction (W direction), and the first main surface 15 and the second main surface 16 opposing each other in the height direction (T direction). It is preferable that corner portions and ridge line portions of the element body 110A be rounded.

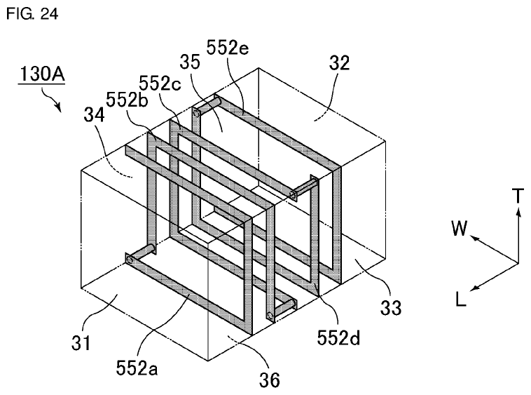

FIG. 24 is a perspective view schematically illustrating an example of a multilayer body that is prepared for fabricating the element body illustrated in FIG. 23.

The element body 110A illustrated in FIG. 23 is obtained by forming the side-margin portion 43 and 44 respectively onto the first side surface 33 and the second side surface 34 of a multilayer body 130A that is illustrated in FIG. 24, the first side surface 33 and the second side surface 34 opposing each other in the width direction (W direction), and forming the side-margin portions 45 and 46 respectively onto the first main surface 35 and the second main surface 36 of the multilayer body 130A, the first main surface 35 and the second main surface 36 opposing each other in the height direction (T direction), and then firing the multilayer body 130A and side-margin portions 43 to 46.

Note that, similar to the element body 110 illustrated in FIG. 19, the boundaries between a portion that corresponds to the multilayer body 130A and the side-margin portions 43 to 46 do not necessarily appear clearly in the element body 110A illustrated in FIG. 23.

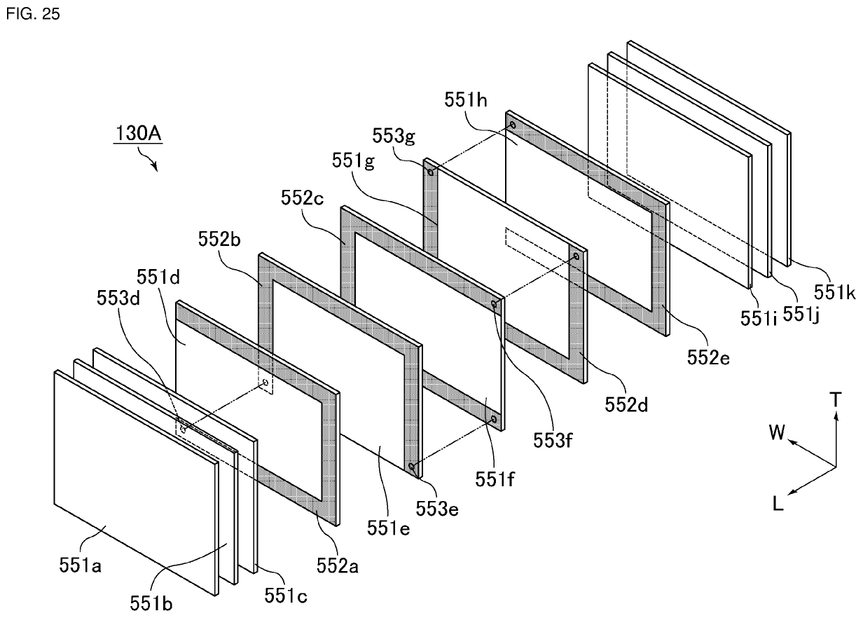

FIG. 25 is an exploded perspective view of the multilayer body illustrated in FIG. 24.

As illustrated in FIG. 25, the multilayer body 130A includes a plurality of insulating layers 551a, 551b, 551c, 551d, 551e, 551f, 551g, 551h, 551i, 551j, and 551k that are laminated together in the length direction (L direction).

Accordingly, in FIG. 18, FIG. 23, FIG. 24, and FIG. 25, the length direction (L direction) corresponds to the lamination direction.

Coil conductor layers 552a, 552b, 552c, 552d, and 552e are respectively formed on main surfaces of the insulating layers 551d, 551e, 551f, 551g, and 551h. Each of the coil conductor layers 552a to 552e has a substantially cornered U-shape and has a length of about ¾ turns.

In addition, the via conductors 553d, 553e, 553f, and 553g are respectively formed in the insulating layers 551d, 551e, 551f, and 551g such that these via conductors extend through the corresponding insulating layers in the lamination direction (the L direction in FIG. 25). A land is usually provided on the main surface of each of these insulating layers so as to be connected to the corresponding via conductor.

As described above, the coil conductor layers 552a to 552e, which are arranged between the insulating layers 551a to 551k, and the via conductors 553d to 553g, which extend through the insulating layers 551d to 551g in the lamination direction, are connected to one another, so that the coil that has a coil axis extending in the L direction is formed.

As illustrated in FIG. 24, the coil conductor layers 552a to 552e are exposed at the first side surface 33, the second side surface 34, the first main surface 35, and the second main surface 36 of the multilayer body 130A.

As illustrated in FIG. 23, the side-margin portion 45 is disposed so as to cover a portion of the first main surface 35 of the multilayer body 130A, and thus, the coil conductor layer 552a is exposed at the first main surface 15 of the element body 110A and connected to the first outer electrode 21 illustrated in FIG. 18. In addition, the side-margin portion 46 is disposed so as to cover a portion of the second main surface 36 of the multilayer body 130A, and thus, the coil conductor layer 552e is exposed at the second main surface 16 of the element body 110A and connected to the second outer electrode 22 illustrated in FIG. 18. Therefore, the first outer electrode 21 and the second outer electrode 22 are electrically connected to the coil.

In contrast, the side-margin portion 43 is disposed so as to cover the entire first side surface 33 of the multilayer body 130A, and the side-margin portion 44 is disposed so as to cover the entire second side surface 34 of the multilayer body 130A, so that the coil conductor layers 552a to 552e are not exposed at the first side surface 13 or the second side surface 14 of the element body 110A.

The element body 110A illustrated in FIG. 23 has the same configuration as the element body 110 illustrated in FIG. 19 except that the coil conductor layer 552a is connected to the first outer electrode 21 and that the coil conductor layer 552e is connected to the second outer electrode 22.

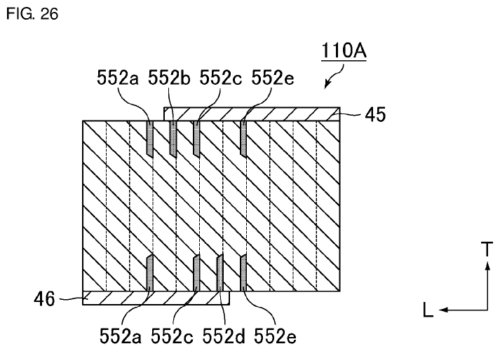

FIG. 26 is a sectional view of the element body illustrated in FIG. 23 taken along line D-D. In other words, FIG. 26 is an LT sectional view of the element body illustrated in FIG. 23.

Similar to FIG. 22, when viewed in cross section in the lamination direction (L direction), the end surfaces of the coil conductor layers 552a to 552e that face outward of the element body 110A are substantially straight in the lamination direction (L direction). In contrast, the end surfaces of the coil conductor layers 552a to 552e that face inward of the element body 110A are inclined with respect to the lamination direction (L direction).

Similar to the multilayer coil component according to the first embodiment of the present disclosure, in the multilayer coil component according to the second embodiment of the present disclosure, when viewed in cross section in the lamination direction, the end surfaces of the coil conductor layers that face outward of the element body are substantially straight in the lamination direction, and the end surfaces of the coil conductor layers that face inward of the element body are inclined or bent with respect to the lamination direction.

The multilayer coil component according to the second embodiment of the present disclosure has the same configuration as the multilayer coil component according to the first embodiment of the present disclosure except that the lamination direction is the same as a direction in which the mounting surface extends.

In the multilayer coil component according to the second embodiment of the present disclosure, the end surfaces of the coil conductor layers that face inward of the element body may be inclined with respect to the lamination direction or may be bent with respect to the lamination direction.

In the multilayer coil component according to the second embodiment of the present disclosure, when the maximum width of one of the coil conductor layers in the direction in which the main surfaces of the insulating layers extend is a, and the maximum thickness of the coil conductor layer in the lamination direction is b, it is preferable that the ratio of b to a (b/a) be about 0.5 or larger and about 2.0 or smaller (i.e., from about 0.5 to about 2.0), and more preferably, about 0.8 or larger and about 2.0 or smaller (i.e., from about 0.8 to about 2.0).

In the multilayer coil component according to the second embodiment of the present disclosure, it is preferable that the maximum thickness of one of the coil conductor layers in the lamination direction be about 25 μm or larger and about 100 μm or smaller (i.e., from about 25 μm to about 100 μm), and more preferably, about 40 μm or larger and about 100 μm or smaller (i.e., from about 40 μm to about 100 μm).

In the multilayer coil component according to the second embodiment of the present disclosure, it is preferable that the maximum width of one of the coil conductor layers in the direction in which the main surfaces of the insulating layers extend be about 12.5 μm or larger and about 200 μm or smaller (i.e., from about 12.5 μm to about 200 μm), and more preferably, about 20 μm or larger and about 100 μm or smaller (i.e., from about 20 μm to about 100 μm).

In the multilayer coil component according to the second embodiment of the present disclosure, it is preferable that the thickness (the length indicated by X in FIG. 22) of each of the side-margin portions, which are positioned between the end surfaces of the plurality of coil conductor layers that face outward of the element body and one of the outer surfaces of the element body, be about 5 μm or larger and about 20 μm or smaller (i.e., from about 5 μm to about 20 μm).

In the multilayer coil component according to the second embodiment of the present disclosure, two or more coil conductor layers may be provided on one insulating layer such that the two or more coil conductor layers are superposed with each other.

In the method of manufacturing the multilayer coil component according to the second embodiment of the present disclosure, although the shape of each of the insulating layers, the positions at which the outer electrodes are to be formed, and so forth are slightly different from those in the method of manufacturing the multilayer coil component according to the first embodiment of the present disclosure, this method is similar to the method of manufacturing the multilayer coil component according to the first embodiment of the present disclosure, and thus, detailed description thereof will be omitted.

For example, the multilayer coil component that includes the element body illustrated in FIG. 19 can be manufactured by a method similar to the method of manufacturing the multilayer coil component that includes the element body illustrated in FIG. 2, and the multilayer coil component that includes the element body illustrated in FIG. 23 can be manufactured by a method similar to the method of manufacturing the multilayer coil component that includes the element body illustrated in FIG. 14.

### Other Embodiments

The multilayer coil component of the present disclosure is not limited to the above-described embodiments, and various applications and modifications can be made to the configuration, the manufacturing conditions, and so forth of the multilayer coil component within the scope of the present disclosure.

For example, the number of the insulating layers, the shape and the material of each of the insulating layers, the length, the shape, and the material of each of the coil conductor layers, the number of the via conductors, the positions of the via conductors, the shape and the material of each of the via conductors, the configuration of the coil, the shape and the material of each of the outer electrodes, the method of forming the outer electrodes, the method of connecting the coil and each of the outer electrodes, and so forth are not particularly limited. For example, the length of each of the coil conductor layers is not limited to about ¾ turns and may be, for example, about ½ turns. The shape of each of the coil conductor layers may be cornered or may be rounded. In addition, the coil does not need to be formed of the plurality of coil conductor layers and the via conductors connected to one another, and for example, the coil may be formed of a single coil conductor layer.

In the multilayer coil component of the present disclosure, the method of forming each of the outer electrodes may be a method in which an electrode conductor layer that is embedded in the element body is exposed by cutting and in which plating is performed on the electrode conductor layer.

In the multilayer coil component of the present disclosure, examples of the material of the insulating layers include inorganic materials such as a glass material and a ferrite material, organic materials such as an epoxy resin, a fluorocarbon resin and a polymer resin, and a composite material such as a glass epoxy resin.

In the case where the lamination direction is the same as a direction in which the mounting surface extends, the lamination direction may be the L direction or may be the W direction.

In each of the above embodiments, a case has been described in which a multilayer coil component is manufactured by a sheet lamination method in which insulating sheets that are to be insulating layers and on which coil-conductor-layer patterns have been formed are laminated together. However, in the present disclosure, the multilayer coil component may be manufactured by a printing lamination method in which application of an insulating paste and application of an electrically conductive paste are repeatedly performed so as to sequentially form insulating layers and coil-conductor-layer patterns. Alternatively, the multilayer coil component may be manufactured by a photolithography method.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A multilayer coil component comprising:
an element body that includes a plurality of insulating layers laminated together;
a coil that is embedded in the element body and that includes a plurality of coil conductor layers provided between the insulating layers; and
a first outer electrode and a second outer electrode, each of which is provided on an outer surface of the element body and each of which is electrically connected to the coil,
wherein, when viewed in cross section in a lamination direction in which the plurality of insulating layers are laminated together, end surfaces of the coil conductor layers, the end surfaces facing outward of the element body, are substantially straight in the lamination direction, and end surfaces of the coil conductor layers, the end surfaces facing inward of the element body, are inclined or bent with respect to the lamination direction.

2. The multilayer coil component according to claim 1, wherein
when a maximum width of one of the coil conductor layers in a direction in which main surfaces of the insulating layers extend is a, and a maximum thickness of one of the coil conductor layer in the lamination direction is b, a ratio of b to a (b/a) is from about 0.5 to about 2.0.

3. The multilayer coil component according to claim 1, wherein
a maximum thickness of one of the coil conductor layers in the lamination direction is from about 25 μm to about 100 μm.

4. The multilayer coil component according to claim 1, wherein
two or more of the coil conductor layers are provided on one of the insulating layers such that the two or more coil conductor layers are superposed with one another.

5. The multilayer coil component according to claim 1, wherein
a side-margin portion that is positioned between the end surfaces of the plurality of coil conductor layers that face outward of the element body and the outer surface of the element body has a thickness of from about 5 μm to about 20 μm.

6. The multilayer coil component according to claim 1, wherein
the lamination direction is perpendicular to a direction in which a mounting surface extends.

7. The multilayer coil component according to claim 1, wherein
the lamination direction is the same as a direction in which a mounting surface extends.

8. The multilayer coil component according to claim 2, wherein
the maximum thickness of one of the coil conductor layers in the lamination direction is from about 25 μm to about 100 μm.

9. The multilayer coil component according to claim 2, wherein
two or more of the coil conductor layers are provided on one of the insulating layers such that the two or more coil conductor layers are superposed with one another.

10. The multilayer coil component according to claim 3, wherein
two or more of the coil conductor layers are provided on one of the insulating layers such that the two or more coil conductor layers are superposed with one another.

11. The multilayer coil component according to claim 2, wherein
a side-margin portion that is positioned between the end surfaces of the plurality of coil conductor layers that face outward of the element body and the outer surface of the element body has a thickness of from about 5 μm to about 20 μm.

12. The multilayer coil component according to claim 3, wherein
a side-margin portion that is positioned between the end surfaces of the plurality of coil conductor layers that face outward of the element body and the outer surface of the element body has a thickness of from about 5 μm to about 20 μm.

13. The multilayer coil component according to claim 4, wherein
a side-margin portion that is positioned between the end surfaces of the plurality of coil conductor layers that face outward of the element body and the outer surface of the element body has a thickness of from about 5 μm to about 20 μm.

14. The multilayer coil component according to claim 2, wherein
the lamination direction is perpendicular to a direction in which a mounting surface extends.

15. The multilayer coil component according to claim 3, wherein
the lamination direction is perpendicular to a direction in which a mounting surface extends.

16. The multilayer coil component according to claim 2, wherein
the lamination direction is the same as a direction in which a mounting surface extends.

17. The multilayer coil component according to claim 3, wherein
the lamination direction is the same as a direction in which a mounting surface extends.

18. A method of manufacturing a multilayer coil component comprising:
fabricating a mother multilayer body including a plurality of insulating layers that are laminated together and a coil-conductor-layer pattern that is provided between the insulating layers;
dividing the mother multilayer body into a plurality of green multilayer bodies each of which includes a coil that is formed of a coil conductor layer provided between the laminated insulating layers by cutting the mother multilayer body, the green multilayer bodies each having a cut surface that is formed as a result of cutting the mother multilayer body and at which the coil conductor layer is exposed;
forming a side-margin portion on the cut surface of each of the multilayer bodies, at which the coil conductor layer is exposed, by using an insulating material; and
firing the multilayer bodies each of which includes the side-margin portion.

19. The method of manufacturing a multilayer coil component according to claim 18, wherein
the coil-conductor-layer pattern is formed on at least one of the insulating layers such that the coil conductor layers of the multilayer bodies that are adjacent to each other are continuous with each other.

20. The method of manufacturing a multilayer coil component according to claim 18, wherein
the coil-conductor-layer pattern is formed on at least one of the insulating layers such that the coil conductor layers of the multilayer bodies that are adjacent to each other are spaced apart from each other.
